(19) United States
(12) Patent Application Publication
(10) Pub. No.: US 2002/0020219 A1
(43) Pub. Date: Feb. 21, 2002

(54) Method of driving MEMS sensor with balanced four-phase comb drive

(76) Inventors: David W. DeRoo, Newport Beach, CA (US); Ying W. Hsu, Huntington Beach, CA (US)

Correspondence Address: Joseph C. Andras, MYERS DAWES & ANDRAS LLP, Suite 1150, 19900 MacArthur Blvd., Irvine, CA, 92612, US

(21) Appl. No.: 09/808,385

(22) Filed: Mar. 13, 2001

Related U.S. Application Data
(60) Provisional application No. 60/188,780, filed on Mar. 13, 2000.

(51) Int. Cl. G01P 3/44; G01C 19/00

(52) U.S. Cl. 73/504.12; 73/504.13

(57) ABSTRACT

Disclosed is a microelectromechanical sensor (10) with an element (40) that is driven into oscillations with drive forms (φ1, φ2, φ3, φ4) through the use of arms (50), comb-drives (55A, 55B, 55C, and 55D) and corresponding comb-fingers (51, 61) and wherein a sense signal is transduced with capacitive sense electrodes (26, 26). The driveforms (φ1, φ2, φ3, φ4) are provided in four-phases and are applied in pairs (φ1, φ3 and φ2, φ4) that are 180 degrees out of phase with respect to one another such that the driveforms are substantially self-canceling with regard to any driveform energy that feeds through any parasitic capacitance (99) that connects the comb-drives (55A, 55B, 55C, and 55D) to the capacitive sense electrodes (26, 26).

### FIELD OF THE INVENTION

The present invention relates generally to Micro-Electro-Mechanical Systems (MEMS) and, more particularly, to a MEMS sensor with a balanced four-phase comb drive.

### BACKGROUND OF THE RELATED ART

MEMS sensors are often used in modern day devices because of their small size and low cost. Typical MEMS sensors include accelerometers, angular rate sensors, and pressure sensors, but there are many more.

MEMS sensors often use electrostatic comb-drives that use AC drive signals to drive some part of the system into oscillation and capacitive sense circuits that provide an output signal. The AC drive signals are usually of relatively high voltage (e.g. 5 volts) as compared with the voltages produced by the capacitive sense circuits (e.g. 1 nanovolt). Due to this large disparity in magnitude, the known MEMS sensors often suffer from parasitic capacitance, or “feed-through”. In particular, given current drive methodologies, signals applied to the electrostatic comb-drives are transmitted through the parasitic capacitance that connects the drive-combs to the sense capacitors and thereby swamp the tiny, capacitively-induced sensor voltages. The industry has not adequately addressed this problem prior to this invention.

The problem may be best understood with reference to an exemplary MEMS sensor disclosed in U.S. Pat. No. 5,955,668, a patent that is commonly owned by the assignee of this invention. The ‘668 patent discloses an angular rate sensor, or “micro-gyro,” and hereby incorporated by reference in its entirety.

As typical of many MEMS sensors, the micro-gyro in the ‘668 patent uses electrostatic comb-drive actuators that each consists of two comb structures with partially overlapping comb fingers. In a rate sensor built according to the ‘668 patent, an electrostatic comb-drive structure is used to oscillate an element or “proof mass” so that it is naturally subjected to coriolis forces whenever the device is rotated about a input axis or “rate” axis at some angular rate of rotation.

In the particular design shown, the oscillating element is a ring that is driven into oscillation about a drive axis. In more detail, the ring element is driven into oscillation with an arm that extends radially outward from the ring element. The ring element supports four such arms. Each arm moves back and forth in between a pair of electrode pads. As shown FIG. 4 of the ‘668 patent, the arm supports two sets of outwardly extending comb-fingers and each electrode pad supports a set of inwardly extending comb-fingers.

The ‘668 patent uses a drive methodology that may be regarded as “pull-pull” in that the ring element is repeatedly pulled one way and then pulled the other way using electrostatic forces. In particular, as explained at column 5, lines 11-18 of the ‘668 patent, “[t]he oscillation of ring element 20 may be established by applying a differential voltage between the fingers 50 connected to the ring element and the fingers 52 connected to the electrical pads 46 and 48 mounted on the substrate. By alternating the potential on the electrode pads 46 and 48, ring element 20 can be driven into oscillation around its axis 21, i.e., motion of each arm 44 back and forth between electrode pads 46 and 48.”

As first discussed above with regard to MEMS sensors in general, the micro-gyro of the ‘668 patent relies on capacitive sensing. In particular, an inner disk-shaped element is positioned above a pair of electrodes to form a differential pair of parallel capacitors. The inner element is mechanically constrained to oscillate about an output axis or “sense” axis, in a “teeter-tofter” fashion, above the electrodes. As such, when the inner element is oscillating about the sense axis, its capacitance with respect to one electrode is increasing in value while its capacitance with respect to the other electrode is decreasing in value.

In operation, when the ring element is being driven but the gyro is not rotating about the rate axis, the oscillating ring simply moves back and forth in the same plane and no energy is transferred to the inner element. When the gyro is rotating about the rate axis, however, the oscillating ring begins to tip and tilt as well oscillate about its axis. The ring's tip and tilt energy is dynamically coupled to the inner disk-shaped element such that it begins to rock about the sense axis and change the value of its capacitance with respect to the underlying electrodes.

The ‘668 patent discloses that the ring and the disk are held at a reference value or “virtual ground” of 5 v and that the voltages on the electrodes 46 and 48 are alternated between values above and below the reference value in order to drive the ring 20 into oscillation in an electrostatic “pull-pull” fashion. The voltage that is applied to the electrodes that pull in the counterclockwise direction is always 1 volt and the voltage that is applied to the electrodes that pull in the clockwise direction is 9 volts. At any moment, therefore, there is an “unbalanced” situation which results in feed-through into the capacitance electrodes associated with the sense disk. Under worst case conditions, the sense signal may be completely overpowered by the drive signal.

Electrostatic comb-drive methods are inherently incompatible with capacitive sensing methods because there is always some degree of parasitic feed-through capacitance between the drive-combs and the sense capacitors and because the voltages are so different in terms of magnitude. There remains a need, therefore, for a drive method that minimizes this feed-through problem.

### SUMMARY OF THE INVENTION

In a first aspect, the invention resides in a method of vibrating a proof mass in a microelectromechanical sensor at a desired motor frequency wherein the proof mass is flexibly supported above a substrate with first, second, third and fourth moveable electrodes connected to the proof mass and adjacent to first, second, third and fourth fixed electrodes connected to the substrate, respectively, the method comprising the steps of: applying to the first and third fixed electrodes first and third periodic driveforms that operate to periodically pull the proof mass in the one direction; applying to the second and fourth fixed electrodes second and fourth periodic driveforms that operate to periodically pull the proof mass in the opposite direction; and phasing the first, second, third and fourth periodic driveforms relative to one another to cause the first and third periodic driveforms to pull the proof mass in the one direction during one period of periodic proof mass movement and to cause the second and fourth periodic driveforms to pull the proof mass in the opposite direction in a subsequent period of periodic proof mass movement.

In a second aspect, the invention resides in a method of vibrating a proof mass in a microelectromechanical sensor at a desired motor frequency wherein the proof mass is flexibly supported above a substrate with first, second, third and fourth moveable electrodes connected to the proof mass and adjacent to first, second, third and fourth fixed electrodes connected to the substrate, respectively, the method comprising the steps of: applying to the first and third fixed electrodes first and third periodic driveforms that periodically pull the proof mass in the one direction, the first and third periodic driveforms being 180 degrees out of phase with respect to one another; and applying to the second and fourth fixed electrodes second and fourth periodic driveforms that periodically pull the proof mass in the opposite direction, the second and fourth periodic driveforms being 180 degrees out of phase with respect to one another.

In a third aspect, the invention resides in a method of driving a proof mass at a desired motor frequency wherein the proof mass is flexibly supported above a substrate in a microelectromechanical sensor, the method comprising the steps of: providing a first movable electrode that is connected to the proof mass and a first fixed electrode for pulling the proof mass in one direction when a voltage differential exists between the first movable electrode and the first fixed electrode; and providing a second movable electrode that is connected to the proof mass and a second fixed electrode for pulling the proof mass in an opposite direction when a voltage differential exists between the second movable electrode and the second fixed electrode; providing a third movable electrode that is connected to the proof mass and a third fixed electrode for helping the first fixed and moveable electrodes pull the proof mass in said one direction when a voltage differential exists between the third movable electrode and the third fixed electrode; providing a fourth movable electrode that is connected to the proof mass and a fourth fixed electrode for helping the second fixed and movable electrodes pull the proof mass in said opposite direction when a voltage differential exists between the third movable electrode and the third fixed electrode; applying to the first fixed electrode a first periodic driveform at a one-half motor frequency that operates to periodically pull the proof mass in the one direction; and applying to the second fixed electrode a second periodic driveform at the half motor frequency that operates to periodically pull the proof mass in the opposite direction; applying to the third fixed electrode a third periodic driveform at a one-half motor frequency that operates to periodically pull the proof mass in the one direction; and applying to the fourth fixed electrode a fourth periodic driveform at a one-half motor frequency that operates to periodically pull the proof mass in the opposite direction, wherein the first and third periodic driveforms are 180 degrees out of phase with respect to one another, wherein the second and fourth periodic drives are 180 degrees out of phase with respect to one another, and wherein the first and second periodic drive forms are substantially ninety degrees out of phase with respect to one another and the third and fourth periodic drive forms are substantially ninety degrees out of phase with respect to one another such that the proof mass is repetitively and alternately pulled back and forth by the first and second periodic driveforms and by the third and fourth periodic driveforms at the motor frequency.

In a fourth aspect, the invention resides in a method of generating drive waveforms for excitation of an oscillating mass driven by electrostatic actuation comprising the steps of: detecting a periodic motion of the oscillating mass with sense electrodes; producing a periodic waveform that is coherent in phase with the periodic motion of the oscillating mass and with a period of even multiple of the periodic motion of the oscillating mass; generating four orthogonal waveforms with phases of 0°, 90°, 180°, and 270°, and whose edges are coincident with a peak amplitude of the oscillating mass; and summing the orthogonal waveforms together to form a four-phase set of drive signals that produce torque over the entire sensor motor duty cycle.

### BRIEF DESCRIPTION OF THE DRAWINGS

The just summarized invention can be best understood with reference to the following description taken in view of the drawings of which:

FIG. 1 is a top plan view of a micro-gyro 10 that uses the four-phase drive method of this invention;

FIG. 2 is a block diagram of a preferred motor drive control circuit 200 used to drive the micro-gyro of, FIG. 1 according to this invention;

FIG. 3 is a graph of the proof mass or motor response (position versus time) relative to the periodic driveforms (voltage versus time) used to drive the proof mass where the periodic driveforms are presented as sinusoids;

FIG. 4 is a graph that is comparable to FIG. 3 except that the periodic driveforms are stair-stepped approximations of a sinusoidal waveforms;

FIG. 5 is a graph of the presently preferred method of producing the driveforms of FIG. 4;

FIG. 6 is a simplified diagram of a ring-based embodiment driven according to this invention;

FIG. 7 is a simplified diagram of a single-plate embodiment driven according to this invention; and

FIG. 8 is a simplified diagram of a two-plate embodiment driven according to this invention.

### DETAILED DESCRIPTION OF THE PREFERRED EMBODIMENT

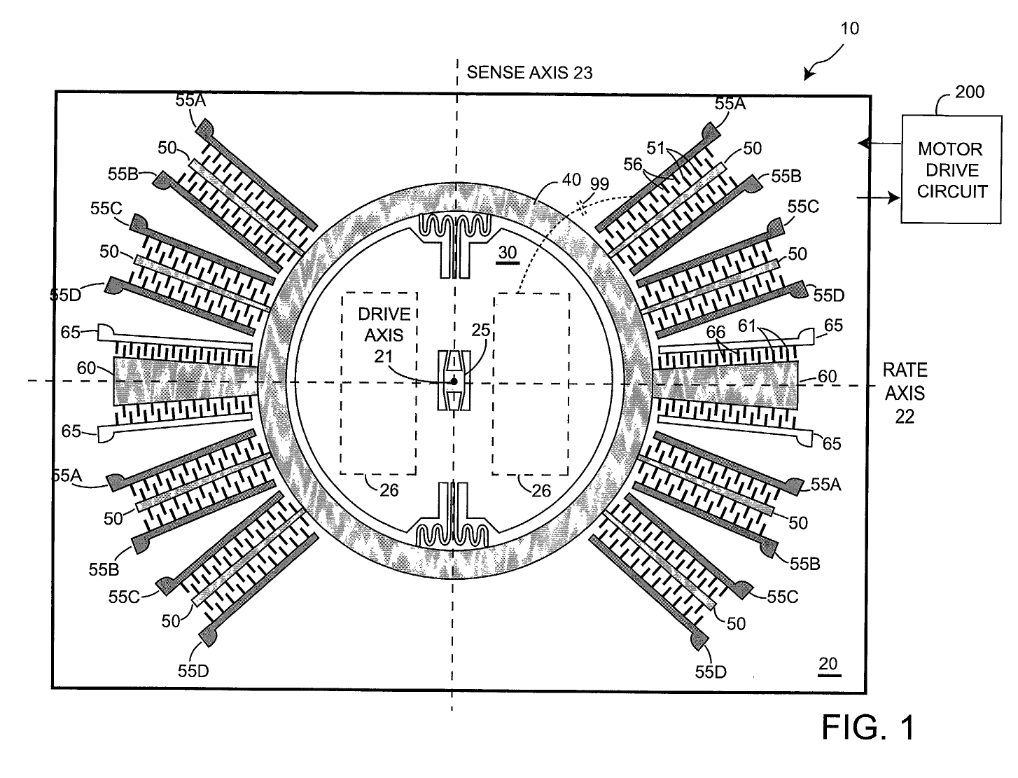

The four-phase driving method of this invention can be used with any variety of MEMS sensors. FIG. 1 is a top plan of an exemplary micro-gyro 10 that may be driven with a balanced four-phase comb-drive as disclosed herein.

The illustrated gyro 10 has three main components: (1) a substrate 20, (2) a plurality of vibrating elements supported above the substrate 20 from a central anchor 25, and (3) a plurality of stationary electrodes located on the substrate 20 for driving, sensing, and adjusting the motion of the vibrating elements. The vibrating elements include an outer ring element 40 that serves as a “proof mass” that responds to coriolis forces in the presence of an angular rate of rotation about a rate axis 22 and an inner sense disk 30 that serves as a sense element by interfacing with a pair of electrodes 26, electrodes 26 are on the substrate 20, and thereby forming a one half of a pair of differential capacitors as taught in the ‘668 patent.

In this particular embodiment, the disk 30 is supported by flexures (not numbered) extending from the anchor 25, and the ring element 40 is thereafter supported by other flexures (not numbered) extending from the disk 30. The flexures supporting the ring element 40 permit it to vibrate about a drive axis 21 that is perpendicular to the plane of FIG. 1 and, as would be expected, to also allow it to tip and tilt in the presence of a coriolis force when the overall gyro 10 is rotating at some angular rate about the rate axis 22. The inner disk 30, by contrast, is mechanically constrained to pivot about sense axis 23 that lies in the plane of FIG. 1. As taught by the ‘668 patent, the tip and tilt energy from the ring element 40 is dynamically coupled to the inner disk 30 by the flexures. As a result, in the presence of an angular rate of rotation, the inner disk 30 will pivot back and forth about the sense axis 23, above the electrodes 26, 26, and thereby produces a differential capacitance that can be detected with suitable electronics.

The ring element 40 is vibrated at a desired frequency with a plurality of driven arms 50 and feedback arms 60 that extend radially outward therefrom. Each driven arm 50 extends between a pair of drive electrodes 55 and each feedback arm 60 extends between a pair of feedback electrodes 65. Finally, in order to form an electrostatic comb-drive structure, the arms 50, 60 and the electrodes 55, 65 include partially overlapping comb-fingers 51, 56 and 61, 66.

As shown, the preferred micro-gyro 10 has ten arms 50, 60. These arms are symmetrically arranged for mechanical balance and clustered left and right so that the overall micro-gyro 10 requires less area. The ten arms include eight driven arms 50 that are used for vibrating the ring element 40 at a desired frequency and two feedback arms 60 that are used to provide position feedback to suitable drive circuitry.

As described above in the background section, and as symbolically suggested by the lumped capacitor shown in dashed lines, a parasitic capacitance 99 may exist between the drive electrodes 55 and the sense electrodes 26, 26 (only one is shown). The parasitic capacitance 99 can be very troublesome because the high drive voltages can “feedthrough” to the sense electrodes 26, 26 and drown out or swamp the much lower sense voltages induced by the rocking disk 30. The present invention offers a balanced four-phase driving method that uniquely addresses this problem.

The drive electrodes 55 that surround the eight driven arms 50 are provided in four different groups that correspond to four different driveform phases that are uniquely designed to minimize feedthrough voltages. The drive electrodes in the four groups have been suitably designated with different letters, i.e. 55A, 55B, 55C, and 55D. In the FIG. 1 gyro embodiment, there are four members of each group, but there could be as few as one arm in each group in less complex embodiments.

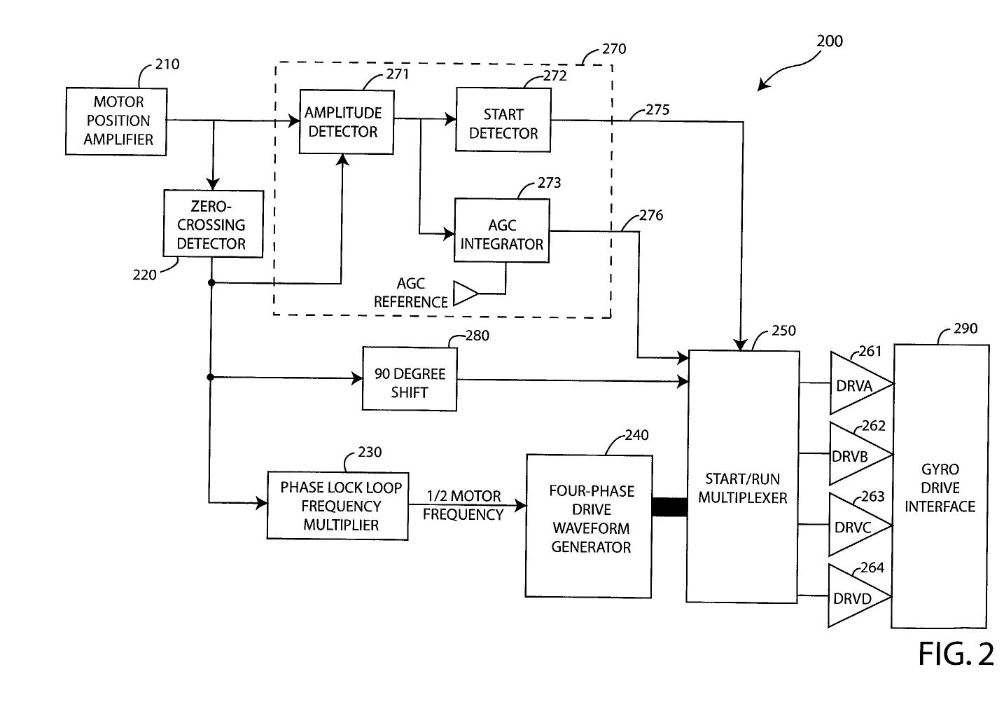

FIG. 2 is a block diagram of a preferred motor drive control circuit 200 used to drive the micro-gyro of FIG. 1 according to this invention. As a starting point, it is assumed that the sensor motor has been set into low level motion by a conventional positive feedback scheme. A phase lock loop 230 detects this low level of motion and produces a phase coherent signal at half the frequency of sensor motor motion. In this unique motor control design, motor motion is pendulous and excitation can be provided at both ends of the pendulum.

A key advantage of the four-phase drive circuit 200 and underlying drive methodology is that it can increase the motor drive efficiency by driving the gyro motor pull-pull as opposed to “pull-release”. This results in a lower drive voltage that translates to a lower cost device. In addition, the drive frequency is only one-half the motor frequency instead of at the full motor frequency.

As shown, the preferred motor drive control circuit 200 includes a motor sense amplifier 210, a zero crossing detector 220, a phase lock loop 230, a four-phase driveform generator 240, a start/run multiplexer 250, motor drive circuits 261-264, and automatic gain control startup circuits 270. The PLL 230 is not required to generate the four-phase motor drive in an all-analog approach. The PLL approach was required to generate high frequency signals, used in other circuits, synchronized with the motor frequency. The four-phase driveform generator 240, with the PLL 230, is implemented using two flip-flops (not shown). When in the normal operating mode, the start/run multiplexer 250 inputs motor drive signals from the four-phase driveform generator 240 and PLL 230. At start up, the PLL 230 requires time to lock onto the motor frequency. The PLL 230, therefore, is bypassed and the motor signal is inputted directly via the zero crossing detector 220 and a 90 degree phase shift circuit 280. In addition, at startup the drive is at the motor frequency therefore only two signals (at 180-degree phase separation) of the four phases are used. The start/run multiplexer 250 is implanted using analog FET switches in a conventional multiplexer design. The start detector 272 in the ACG startup circuits 270 controls the switches in the multiplexer 250. When the motor is running, the AGC signal is within normal operating range, and the PLL 230 is locked onto the motor drive, the multiplexer 250 switches in the four-phase drive at one-half the motor frequency. The integrated ACG signal 276 controls the gyro sensor displacement by amplitude modulating the four-phase motor drive. The motor drive control circuit 200 can be implemented with operational amplifiers or switched capacitor circuits because the motor input is represented by very small value capacitors and no DC gain is required.

The AGC circuits 270 consists of an amplitude detector or rectifier circuit 271 with inputs from the motor position amplifier 210 and the zero crossing detector 220. This rectified motor signal is filtered, amplified and input to a start detector 272 and to an AGC integrator 273. The start detector 272 is a voltage comparator configured as a window detector around the mid-voltage range. Its function is to output a logic ONE when the AGC signal is within operating range, and in other conditions to output a logic ZERO. This logic output controls the start/run multiplexer 250. The AGC integrator 273 integrates the motor differential amplitude and outputs the integrated signal 276 to the motor drive circuits 261-264 to control the motor displacement. The 90-degree shift circuit 280 is required to align the starting force with motor position. The 90-degree shift circuit 280 consists of a first order band pass filter centered at the motor frequency.

The periodic driveforms may be of any desired shape including, for example, a true sinudosoid, a sawtooth, a square wave, or a series of square wave pulses. In all cases, however, the periodic driveforms will comprise first and third periodic driveforms that periodically pull the proof mass in one direction and second and fourth periodic driveforms that periodically pull the proof mass in the other direction.

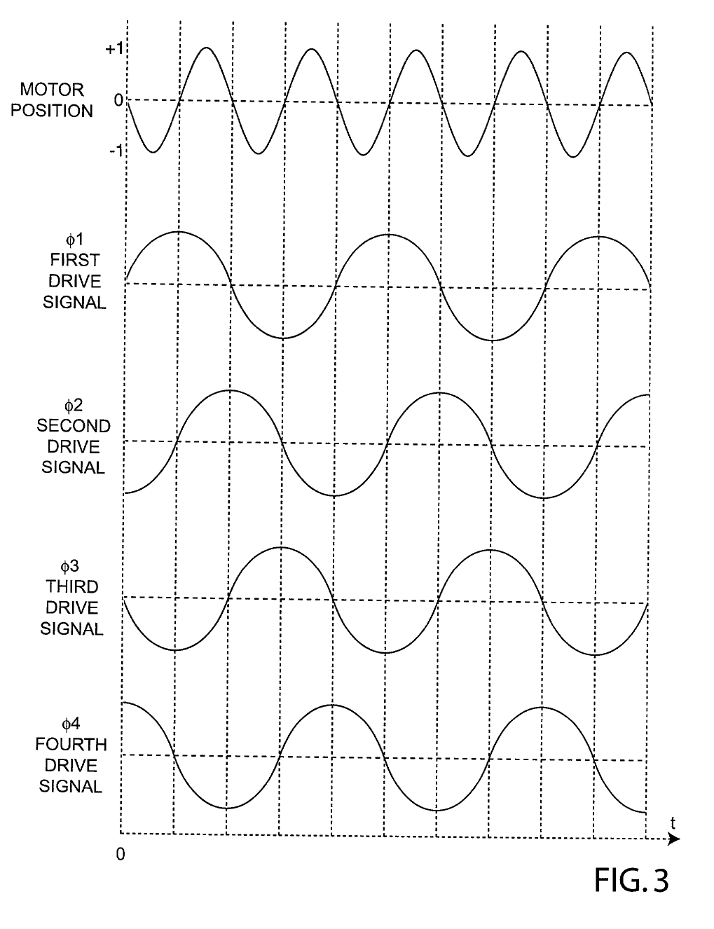

FIG. 3 is a graph of the proof mass or motor response (position versus time) relative to the periodic four-phase driveforms (voltage versus time) used to drive the proof mass where the periodic four-phase driveforms are presented as sinusoids. As shown, the first and third drive signals φ1 and φ3 are 180 degrees out of phase and the second and fourth drive signals φ2 and φ4 are 180 degrees out of phase.

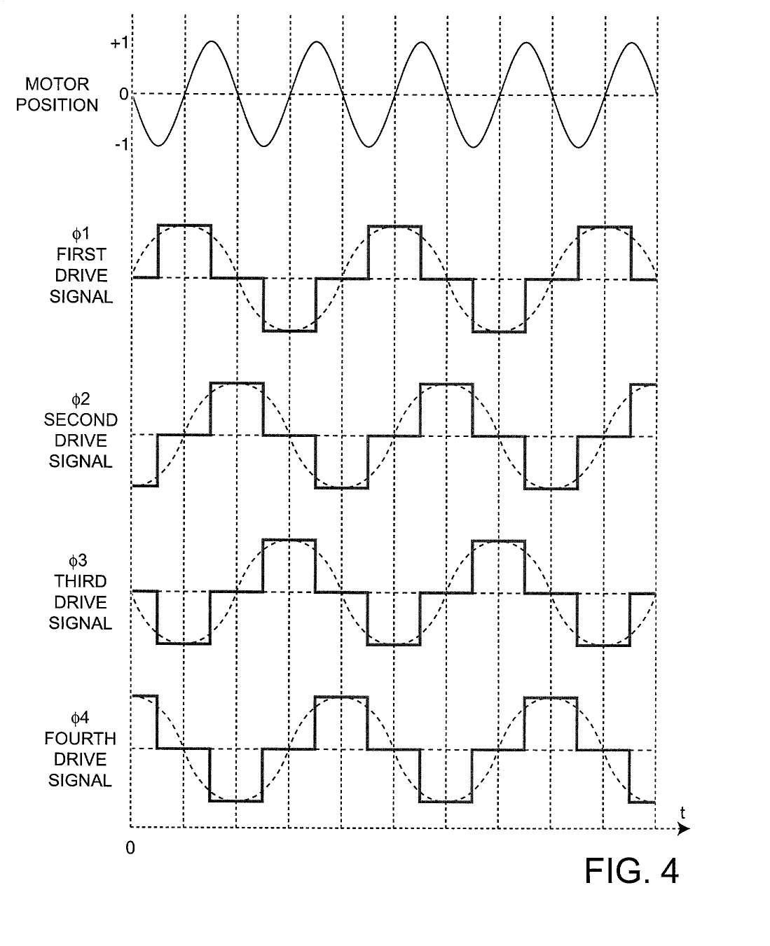

FIG. 4 is a graph of the preferred driveforms that are provided as square pulse driveforms. They are comparable to the driveforms of FIG. 3 in that they are stair-stepped approximations of sinusoidal waveforms as suggested by the inclusion of the sinusoidal waveforms in dashed lines. In this embodiment, where the system operates on a conventional 5 volt supply, the driveforms are centered about a virtual ground of 2.5 volts and the driveforms are 2.5 volts +1.8 volts. The edges of the square pulse driveforms are coincident with the peak amplitudes of motor motion. This combination of drive excitation voltage provides a composite drive at one-half of the motor frequency, but does not produce any electrical interference at the sense frequency.

Of significance, the driveforms are applied such that capacitively coupled voltage is opposite in phase and will be self-canceling to a high degree in accordance with this invention. In particular, as suggested by FIG. 1, the first and third drive signals φ1 and φ3 are simultaneously applied to drive electrodes 55A and 55C in order to pull the ring element 40 in the counterclockwise direction with minimal feedthrough and the second and fourth drive signals φ2 and φ4 are simultaneously applied to drive electrodes 55B and 55D in order to pull the ring element in the clockwise direction with minimal feedthrough. As a result of the phase cancellation, there will be a relative cancellation of parasitic capacitance or drive tones and, therefore, less distortion of the sensed rate signal generated by the movement of the disk 30 above the electrodes 26, 26.

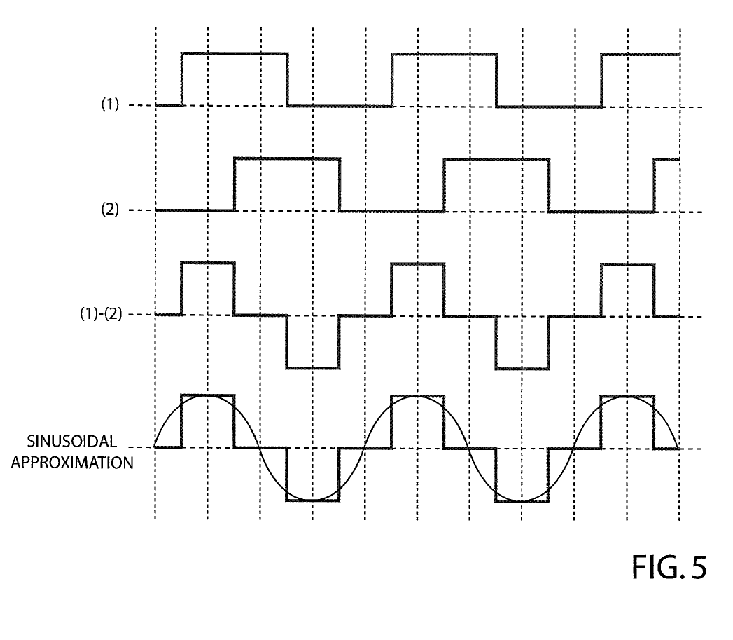

FIG. 5 is a graph of the presently preferred method of producing the driveforms of FIG. 4 wherein a first half-frequency square wave (1), and a second half-frequency square wave (2) that is phase shifted relative to the first are subtracted from one another (1)−(2) to generate the basic driveform of FIG. 3.

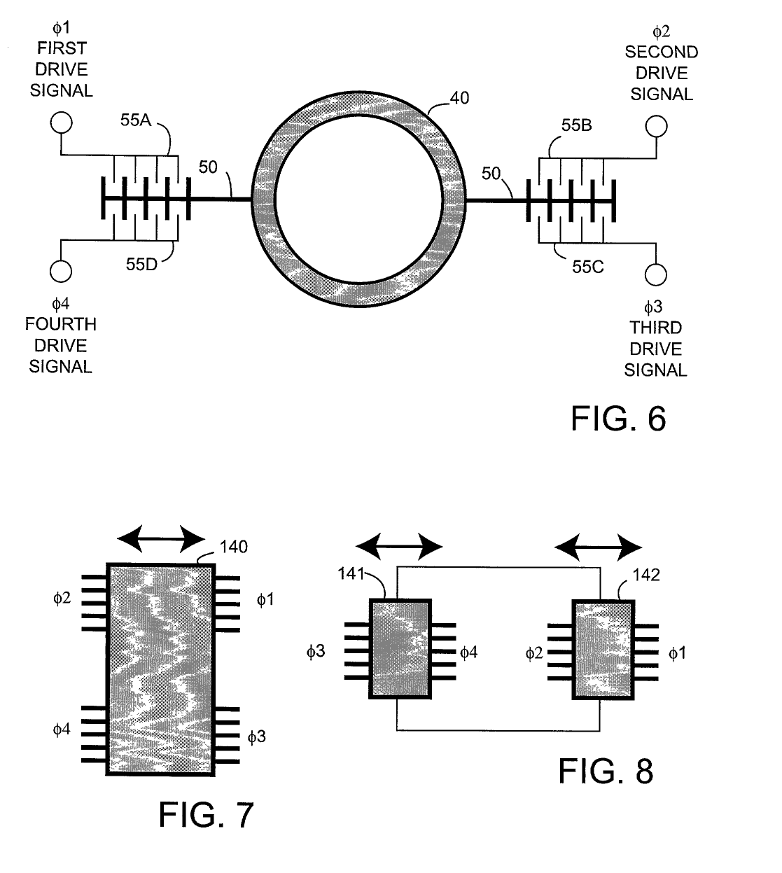

FIG. 6 is a simplified diagram of a ring-based gyro with the minimum number of arms 50 and drive electrodes 55A, 55B, 55C, and 55D required to implement the drive method of this invention. This figure is offered to clarify that FIG. 1 is but a preferred embodiment.

FIGS. 7 and 8 are offered to show that the drive method of this invention may be applied to a variety of geometries. In particular, FIG. 7 is a simplified diagram of a driven plate embodiment wherein the first through fourth driveforms are applied to a MEMS sensor having a plate-shaped proof mass 140. FIG. 8, on the other hand, is a simplified diagram of a two-mass system wherein the first through fourth driveforms are suitably applied to first and second plate-shaped masses 141,142.

We claim:

1. A method of vibrating a proof mass in a microelectromechanical sensor at a desired motor frequency wherein the proof mass is flexibly supported above a substrate with first, second, third and fourth moveable electrodes connected to the proof mass and adjacent to first, second, third and fourth fixed electrodes connected to the substrate, respectively, the method comprising the steps of:
applying to the first and third fixed electrodes first and third periodic driveforms that operate to periodically pull the proof mass in one direction;
applying to the second and fourth fixed electrodes second and fourth periodic driveforms that operate to periodically pull the proof mass in the opposite direction; and
phasing the first, second, third and fourth periodic driveforms relative to one another to cause the first and third periodic driveforms to pull the proof mass in the one direction during one period of periodic proof mass movement and to cause the second and fourth periodic driveforms to pull the proof mass in the opposite direction in a subsequent period of periodic proof mass movement.

2. The method of claim 1 wherein the first, second, third and fourth periodic driveforms are successively ninety degrees out of phase with respect to one another.

3. The method of claim 1 wherein the first and third periodic driveforms are 180 degrees out of phase with respect to one another and wherein the second and fourth periodic driveforms are 180 degrees out of phase with respect to one another such that an equal and opposite voltage differential is always applied at any one time, providing for cancelation of applied voltage and minimize feedthrough to sensors located elsewhere in the microelectromechanical sensor.

4. The method of claim 1 wherein there are multiple sets of first, second, third and fourth fixed and moveable electrodes in the microelectromechanical sensor and further comprising the step of simultaneously applying the first, second, third and fourth periodic drive forms to the respectively numbered fixed electrodes of each set, increasing the amplitude of movement given a particular operating voltage and operating environment.

5. The method of claim 1 further comprising the steps of:
detecting the movement of the oscillating proof mass; and
maintaining phase coherence between the oscillating proof mass and the driveforms based on the detected movement.

6. A method of vibrating a proof mass in a microelectromechanical sensor at a desired motor frequency wherein the proof mass is flexibly supported above a substrate with first, second, third and fourth moveable electrodes connected to the proof mass and adjacent to first, second, third and fourth fixed electrodes connected to the substrate, respectively, the method comprising the steps of:
applying to the first and third fixed electrodes first and third periodic driveforms that periodically pull the proof mass in the one direction, the first and third periodic driveforms being 180 degrees out of phase with respect to one another; and
applying to the second and fourth fixed electrodes second and fourth periodic driveforms that periodically pull the proof mass in the opposite direction, the second and fourth periodic driveforms being 180 degrees out of phase with respect to one another.

7. The method of claim 6 wherein the first, second, third and fourth periodic driveforms are ninety degrees out of phase with respect to one another such that the proof mass is repetitively pulled back and forth by the first and third second periodic driveforms one the one hand, and by the second and fourth periodic driveforms on the other hand, collectively providing a desired amplitude of movement at a given motor frequency, supply voltage, and operating environment.

8. A method of driving a proof mass at a desired motor frequency wherein the proof mass is flexibly supported above a substrate in a microelectromechanical sensor, the method comprising the steps of:
providing a first movable electrode that is connected to the proof mass and a first fixed electrode for pulling the proof mass in one direction when a voltage differential exists between the first movable electrode and the first fixed electrode; and
providing a second movable electrode that is connected to the proof mass and a second fixed electrode for pulling the proof mass in an opposite direction when a voltage differential exists between the second movable electrode and the second fixed electrode.
providing a third movable electrode that is connected to the proof mass and a third fixed electrode for helping the first fixed and moveable electrodes pull the proof mass in said one direction when a voltage differential exists between the third movable electrode and the third fixed electrode;
providing a fourth movable electrode that is connected to the proof mass and a fourth fixed electrode for helping the second fixed and movable electrodes pull the proof mass in said opposite direction when a voltage differential exists between the third movable electrode and the third fixed electrode;
applying to the first fixed electrode a first periodic driveform at a one-half motor frequency that operates to periodically pull the proof mass in the one direction; and
applying to the second fixed electrode a second periodic driveform at the half motor frequency that operates to periodically pull the proof mass in the opposite direction,
applying to the third fixed electrode a third periodic driveform at a one-half motor frequency that operates to periodically pull the proof mass in the one direction; and
applying to the fourth fixed electrode a fourth periodic driveform at a one-half motor frequency that operates to periodically pull the proof mass in the opposite direction,
wherein the first and third periodic driveforms are 180 degrees out of phase with respect to one another,
wherein the second and fourth periodic drives are 180 degrees out of phase with respect to one another, and
wherein the first and second periodic drive forms are substantially ninety degrees out of phase with respect to one another and the third and fourth periodic drive forms are substantially ninety degrees out of phase with respect to one another such that the proof mass is repetitively and alternately pulled back and forth by the first and second periodic driveforms and by the third and fourth periodic driveforms at the motor frequency.

9. The method of claim 8 wherein the first and second periodic driveforms are sinuosoidal approximations.

10. The method of claim 8 wherein the sinusoidal approximations are stepped approximations of a sinusoid.

11. The method of claim 8 wherein the first and second periodic driveforms are sinuosoids.

12. The method of claim 8 wherein the first and second periodic driveforms are sawtooth waves.

13. The method of claim 8 wherein the microelectromechanical sensor is a rotational rate sensor.

14. The method of claim 13 wherein the proof mass is a ring that is driven to oscillate in a plane about a central axis.

15. The method of claim 8 wherein the first and second fixed electrodes are connected to the substrate.

16. The method of claim 15 wherein the third and fourth fixed electrodes are connected to the substrate.

17. A method of generating drive waveforms for excitation of an oscillating mass driven by electrostatic actuation comprising the steps of:
detecting a periodic motion of the oscillating mass with sense electrodes;
producing a periodic waveform that is coherent in phase with the periodic motion of the oscillating mass and with a period of even multiple of the periodic motion of the oscillating mass;
generating four orthogonal waveforms with phases of 0°, 90°, 180°, and 270°, and whose edges are coincident with a peak amplitude of the oscillating mass; and
summing the orthogonal waveforms together to form a four-phase set of drive signals that produce torque over the entire sensor motor duty cycle.
